(19) United States
(12) Patent Application Publication
(10) Pub. No.: US 2010/0131915 A1
(43) Pub. Date: May 27, 2010

(54) Method, device, and program for predicting a manufacturing defect part of a semiconductor device

(75) Inventor: Keisuke Hirabayashi, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC ELECTRONICS CORPORATION, Kawasaki (JP)

(21) Appl. No.: 12/585,444

(22) Filed: Sep. 15, 2009

(30) Foreign Application Priority Data
Nov. 25, 2008 (JP) 299324/2008

(51) Int. Cl. G06F 17/50

(52) U.S. Cl. 716/21; 716/21; 716/1

(57) ABSTRACT

Provided is a method of predicting a manufacturing defect part of a semiconductor device, which results from optical pattern displacement in an exposure process. The prediction method includes: performing repetitive processing a plurality of times, the repetitive processing including: a site generating step of setting a site at a predetermined position of a layout pattern; an edge shifting step of shifting an edge of the layout pattern according to a predetermined rule; an image forming position calculating step of calculating an image forming position corresponding to the shifted edge on the site; and an error check step of storing error information between the image forming position on the site and the edge of the layout pattern; and extracting, based on the error information, from the first layout data, apart in which the image forming position is unstable, and predicting the extracted part as a hot spot.

### BACKGROUND OF THE INVENTION

1. Field of the Invention

The present invention relates to a method, device, and program for predicting a manufacturing defect part of a semiconductor device, which are used in optical proximity correction (OPC) processing in which optical proximity correction is performed on a circuit pattern to be formed on a semiconductor substrate.

2. Description of the Related Art

In recent years, a manufacturing process for a semiconductor has been proceeding toward finer patterning. Along with this trend toward finer patterning, in an exposure process of the manufacturing process for a semiconductor, displacement between a reticle pattern and a circuit pattern actually formed on a semiconductor substrate has becoming increasingly conspicuous due to an optical proximity effect. Here, the reticle pattern refers to an exposure mask, which has a pattern based on image data (hereinafter, referred to as GDS data) of a circuit pattern generated in a layout process. Further, the optical proximity effect refers to a phenomenon in which, due to an influence of light interference, displacement between a reticle pattern and a pattern actually exposed on a semiconductor substrate occurs.

In JP 2007-248087 A, there is disclosed an example of a method of detecting a manufacturing defect of a semiconductor device, which is caused by the optical proximity effect. In JP 2007-248087 A, edge placement error (EPE) check for checking edge positions is performed on GDS data, and then, a portion in which patterns are in close proximity of each other is extracted as a high-risk part of a lithography defect. Then, after forming a circuit pattern on a semiconductor substrate, a sample dimension measuring method having higher accuracy is applied to the portion extracted as the high-risk part in wafer management after the exposure process. With this configuration, JP 2007-248087 A enables high-accuracy detection of a fault of a semiconductor device, which is caused by a lithography defect.

Further, in order to reduce an influence from the optical proximity effect, the layout process of a semiconductor device recently employs optical proximity correction in which the optical proximity effect is corrected on the GDS data (hereinafter, referred to as optical proximity correction (OPC) processing). JP 2007-536564 A discloses an example of the OPC processing.

FIG. 10 illustrates a processing flow of a wafer imaging modeling and prediction system 100 disclosed in JP 2007-536564 A. As illustrated in FIG. 10, in the OPC processing disclosed in JP 2007-536564 A, first, layout data (silicon model) is generated based on circuit data (design) (102). Then, prediction on silicon (104) is performed, and, based on a result of the prediction on silicon, error detection and reporting (106) are performed with respect to the layout data. Then, an error of the layout data is fixed by an error fixer (108). In this manner, fixed design data is obtained (110).

FIG. 11 illustrates details of the prediction on silicon. As illustrated in FIG. 11, in the prediction on silicon, there is output at least one of a contour prediction of a pattern to be formed on a semiconductor substrate, a hot spot prediction, a sensitivity prediction, a mask error enhancement-factor (MEEF) prediction, a process window prediction, and a normalized image log-slope (NILS) prediction.

In JP 2007-536564 A, before a final layout pattern is created, a high-risk part predicted to have a defect due to the optical proximity effect is extracted. Then, in view of the extracted high-risk part, the layout pattern is fixed, and the OPC processing is performed. With this configuration, JP 2007-536564 A enables improvement in efficiency and accuracy of the OPC processing.

Further, in consideration of the fact that the OPC processing generally takes a considerable amount of time, with regard to improvement in efficiency of the processing, there are disclosed methods for speeding up the processing in JP 2006-126745 A, JP 2008-064820 A, and JP 2008-020751 A. In JP 2006-126745 A, a part in which a defect is likely to occur in lithography (exposure process) is identified in advance, and detection of an error and fix thereof are performed with respect to the identified part alone. In JP 2008-064820 A, a layout pattern is divided into a plurality of blocks, and computers are operated in parallel, to thereby realize the speed-up of the OPC processing. In JP 2008-020751 A, the OPC processing is completed on a block (layout cell) basis, and when the OPC processing is performed on one chip, detection of an error and fix thereof are performed with respect to boundary portions of the blocks.

However, in each of the technologies described in JP 2007-536564 A, JP 2006-126745 A, JP 2008-064820 A, and JP 2008-020751 A, there is generated GDS data (referred to as contour) that is obtained by predicting, through light intensity simulation, a circuit pattern to be formed on a semiconductor substrate in view of the optical proximity effect. After that, design rule check is performed on the contour. Then, based on a result of the design rule check, a high-risk part of a manufacturing defect of a semiconductor device is predicted. In this case, because the light intensity simulation is such arithmetic computations that require a significantly large amount of calculation, it takes a long period of time to generate a contour. Therefore, JP 2007-536564 A, JP 2006-126745 A, JP 2008-064820 A, and JP 2008-020751 A have a problem in that an increased period of time for generating a contour results in an increase in period of time for designing.

### SUMMARY

According to one aspect of the present invention, there is provided a method of predicting a manufacturing defect part of a semiconductor device, which results from optical pattern displacement that occurs in an exposure process of a process of manufacturing the semiconductor device. The prediction method includes: performing repetitive processing a plurality of times, the repetitive processing including: a site generating step of setting a site at a predetermined position of a layout pattern of first layout data generated based on data on a circuit to be formed on a semiconductor substrate; an edge shifting step of shifting an edge of the layout pattern according to a predetermined rule; an image forming position calculating step of calculating an image forming position corresponding to the shifted edge on the site; and an error check step of calculating an error between the image forming position on the site and the edge of the layout pattern, and storing the calculated error as error information; and extracting, based on the error information, from the first layout data, a part in which the image forming position is unstable, and predicting the extracted part as an area having a high risk of a manufacturing defect.

According to another aspect of the present invention, there is provided a device for predicting a manufacturing defect part of a semiconductor device, which results from optical pattern displacement that occurs in an exposure process of a process of manufacturing the semiconductor device. The prediction device includes: a site generating unit for setting a site at a predetermined position of a layout pattern of first layout data generated based on data on a circuit to be formed on a semiconductor substrate; an edge shifting unit for shifting an edge of the layout pattern according to a predetermined rule; an image forming position calculating unit for calculating an image forming position corresponding to the shifted edge on the site; an error check unit for calculating an error between the image forming position on the site and the edge of the layout pattern, and outputting the calculated error as error information; and a hot spot information generating unit for extracting, based on the error information, from the first layout data, a part in which the image forming position is unstable, and predicting the extracted part as a hot spot area having a high risk of a manufacturing defect.

According to a further aspect of the present invention, there is provided a program operated on a computer including a storage device and an arithmetic device, for predicting a manufacturing defect part of a semiconductor device, which results from optical pattern displacement that occurs in an exposure process of a process of manufacturing the semiconductor device. The prediction program causes the arithmetic device to execute: a site generating step of reading out, from the storage device, first layout data generated based on data on a circuit of the semiconductor device, and setting a site at a predetermined position of a layout pattern of the first layout data; an edge shifting step of shifting an edge of the layout pattern according to a predetermined rule; an image forming position calculating step of calculating an image forming position corresponding to the shifted edge on the site; and an error check step of calculating an error between the image forming position on the site and the edge of the layout pattern, and storing the calculated error as error information. The arithmetic device extracts, based on the error information, from the first layout data, a part in which the image forming position is unstable, and predicts the extracted part as an area having a high risk of a manufacturing defect.

In the method, the device, and the program for predicting a manufacturing defect part of a semiconductor device according to the present invention, the edge of the layout pattern of the first layout data is shifted, and the image forming position of the shifted edge on the site is calculated. Then, the error between the image forming position on the site and the edge position of the layout pattern of the first layout data is calculated, to thereby output the error information. In the method, the device, and the program for predicting a manufacturing defect part of a semiconductor device according to the present invention, based on the error information, a portion in which the image forming posit ion of the edge is unstable is predicted as a part having a high risk of a manufacturing defect. Specifically, with the method, the device, and the program for predicting a manufacturing defect part of a semiconductor device according to the present invention, it is possible to predict, without generating a contour, a part having a high risk of a manufacturing defect with simple numerical calculations.

With the method, the device, and the program for predicting a manufacturing defect part of a semiconductor device according to the present invention, it becomes possible to speed up the prediction of a part having a high risk of a manufacturing defect of a semiconductor device.

### BRIEF DESCRIPTION OF THE DRAWINGS

In the accompanying drawings:

FIG. 1 is a flow chart illustrating processing of a method of predicting a manufacturing defect part of a semiconductor device according to a first embodiment of the present invention;

FIGS. 2A to 2G illustrate an example of a layout pattern in which a hot spot does not occur;

FIG. 3 is a graph illustrating a convergence state of an error in the layout pattern illustrated in FIGS. 2A to 2G;

FIGS. 4A to 4E illustrate a first example of layout patterns in which a hot spot occurs;

FIGS. 5A to 5E illustrate a second example of the layout patterns in which a hot spot occurs;

FIG. 6 is a graph illustrating a convergence state of errors in the layout patterns illustrated in FIGS. 4A to 4E and 5A to 5E;

FIGS. 7A to 7E illustrate a third example of the layout patterns in which a hot spot occurs;

FIG. 8 is a graph illustrating a convergence state of an error in the layout patterns illustrated in FIGS. 7A to 7E;

FIG. 9 is a block diagram of a device for predicting a manufacturing defect part of a semiconductor device according to the first embodiment;

FIG. 10 is a flow chart illustrating processing of a method of predicting a manufacturing defect part of a semiconductor device, which is described in JP 2007-536564 A; and

FIG. 11 is a diagram illustrating details of a flow of prediction on silicon of the flow chart illustrating the processing of the prediction method for a manufacturing defect part of a semiconductor device, which is described in JP 2007-536564 A.

### DETAILED DESCRIPTION OF THE PREFERRED EMBODIMENT

### First Embodiment

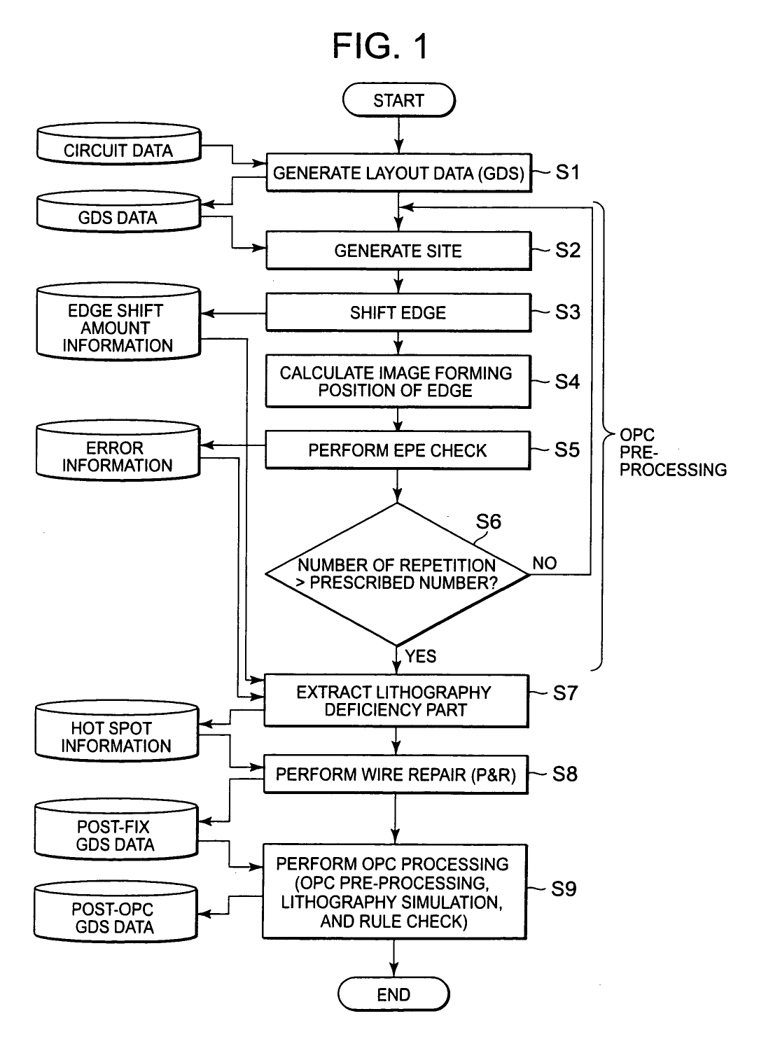

Hereinbelow, description is given of an embodiment of the present invention with reference to the attached drawings. FIG. 1 illustrates a flow chart of a method of predicting a manufacturing defect part of a semiconductor device according to this embodiment. Of a semiconductor design process according to this embodiment, the flow chart of FIG. 1 illustrates a flow of optical proximity correction (OPC) processing performed on layout data. In this embodiment, before the flow chart illustrated in FIG. 1 is started, a circuit design process is performed, and after the flow chart illustrated in FIG. 1 is finished, reticle manufacturing and semiconductor manufacturing process are further performed. Incidentally, the prediction of a manufacturing defect part of a semiconductor device according to this embodiment is performed as one processing step included in the OPC processing. However, the prediction of a manufacturing defect part may be performed as processing independent of the rest of the processing.

As illustrated in FIG. 1, in the method of predicting a manufacturing defect part of a semiconductor device according to this embodiment, first layout data is generated based on circuit data generated in the circuit design process (Step S1). The first layout data, which is image data generated based on the circuit data, is hereinbelow referred to as GDS data.

Subsequently, in the prediction of a manufacturing defect part of a semiconductor device according to this embodiment, a processing flow, which is OPC pre-processing included in the OPC processing, is used to predict a part (hot spot) having a high risk of occurrence of a defect part in an exposure process (lithography). In the OPC pre-processing, there is simply used a processing flow of the OPC processing performed in Step S9 described below, and definitive optical proximity correction is not performed with respect to a first layout pattern.

In the OPC pre-processing, first, the GDS data generated in Step S1 is read out, and then, a site is set on a layout pattern of the GDS data (Step S2). Here, the site is information represented by a straight line that intersects an edge of the layout pattern of the GDS data, an edge of a layout pattern obtained after shifting the edge in Step S3 described below, and an image forming position calculated through processing of calculating an edge image forming position performed in Step S4 described below. Then, in Steps S4 and S5, intersection coordinates of the site and a side of a calculation target are calculated.

In a subsequent edge shifting step, for the GDS data read out in Step S2, the edge of the layout pattern is shifted taking an optical proximity effect into account (Step S3). In Step S3, processing of shifting the edge is performed according to a predetermined rule, to thereby perform enlargement or reduction of the pattern width and pattern length of the layout pattern. Then, in the edge shifting step of Step S3, a shift amount of the edge is output as edge shift amount information.

Subsequently, in a step of calculating an edge image forming position, an image forming position corresponding to the position of the edge shifted in Step S3 is calculated (Step S4). In the step of calculating an edge image forming position, an image forming position is calculated for the shifted edge located on the site, and then, coordinate information of the image forming position is output.

Next, in an error check step (for example, edge placement error (EPE) check), an error between the edge image forming position and the edge position of the layout pattern of the GDS data is calculated, and is output as error information (Step S5). In the error check step, by comparing the coordinate information of the edge image forming position on the site and the coordinate information of the edge position of the layout pattern on the site, the amount of displacement therebetween is calculated.

Then, it is judged whether or not the processing of Steps S2 to S5 has been performed a prescribed number of times (Step S6). In this embodiment, the number of repetition is used as a judgment condition for terminating the OPC pre-processing performed in Steps S2 to S5. Alternatively, the time when the error calculated in the error check step falls below a predetermined value may be used as the termination condition. When the termination condition of Step S6 is not satisfied, Steps S2 to S5 are executed again. On this occasion, the edge shift amount information and the error information, which are calculated in each repetitive processing, are accumulated every time the repetitive processing is performed. On the other hand, when the termination condition of Step S6 is satisfied, the processing proceeds to Step S7.

In Step S7, by using at least one of the edge shift amount information and the error information, a part having a high risk of occurrence of a lithography deficiency is predicted, and then, the predicted part is output as hot spot information. More specifically, a part in which the shift amount of the edge does not converge despite the repetitive processing having been performed a large number of times is predicted as a hot spot having a high risk of occurrence of a lithography deficiency. Further, a part in which an error value contained in the error information does not converge despite an increased number of repetition is also predicted as a hot spot. The hot spot information contains the coordinate information of a pattern of a part in which the shift amount of the edge does not converge or in which the error value of the error information is unstable.

In a subsequent wire repair step, a layout pattern identified by the hot spot information is modified, and then, second layout data (post-fix GDS data) is generated (Step S8). For example, the circuit data and the hot spot information are input to a place-and-route (P & R) tool, to thereby generate the post-fix GDS data having a layout pattern different from that of the first layout data.

Then, in the OPC processing of Step S9, with the post-fix GDS data as input data, the optical proximity correction is performed on the post-fix GDS data, to thereby generate third layout data (post-OPC GDS data). In the OPC processing of Step S9, the OPC pre-processing, lithography simulation, and rule check are performed. On this occasion, in the OPC processing of Step S9, the post-OPC GDS data is output through the OPC pre-processing, and the lithography simulation is performed on the post-OPC GDS data, thereby outputting a contour. Then, the design rule check is performed with respect to the contour. Here, the contour is the outer shape of a layout pattern whose image is formed on a semiconductor substrate when exposure is performed with respect to the post-OPC GDS data. For example, the contour is calculated as information on contour lines of light intensities corresponding to the post-OPC GDS data, and has a shape similar to the outer shape of the layout pattern on the semiconductor substrate.

If it is judged in Step S9 that there is no deficiency in terms of the design rule, the post-OPC GDS data is finalized. It should be noted that, if there is a deficiency in terms of the design rule in Step S9, it is desirable that the processing from Step S2 be performed again.

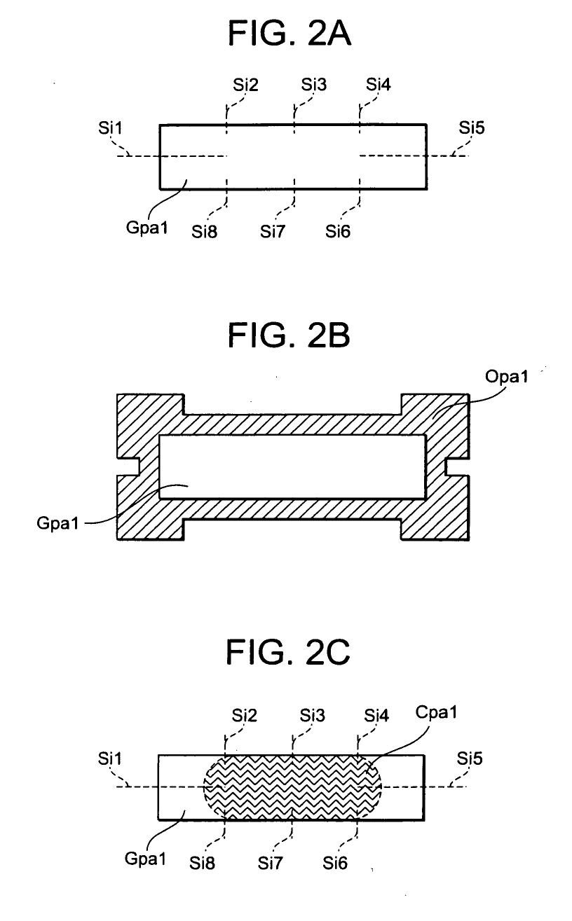

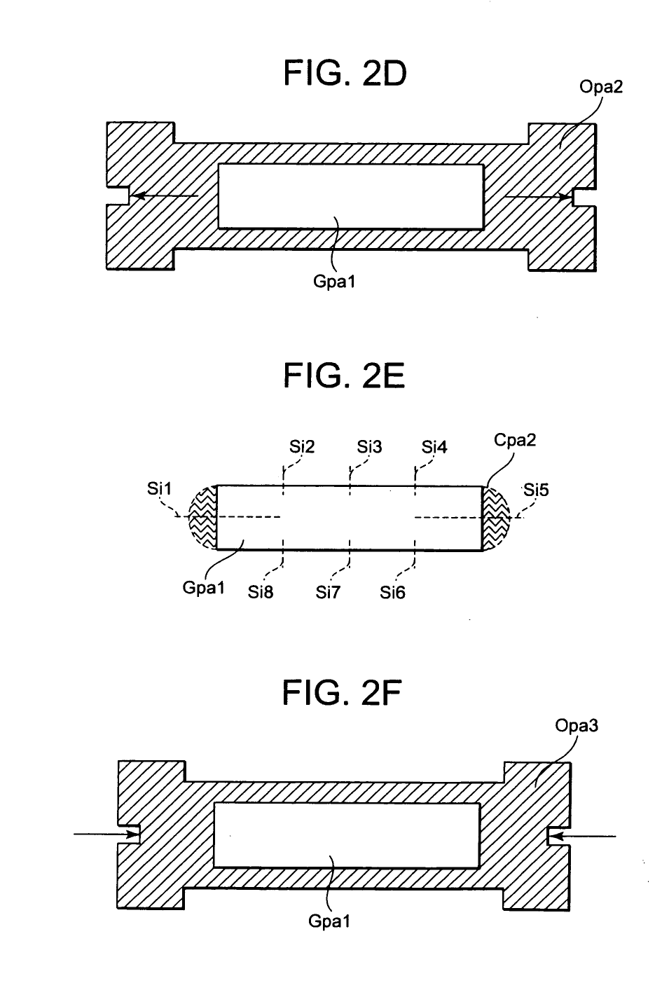

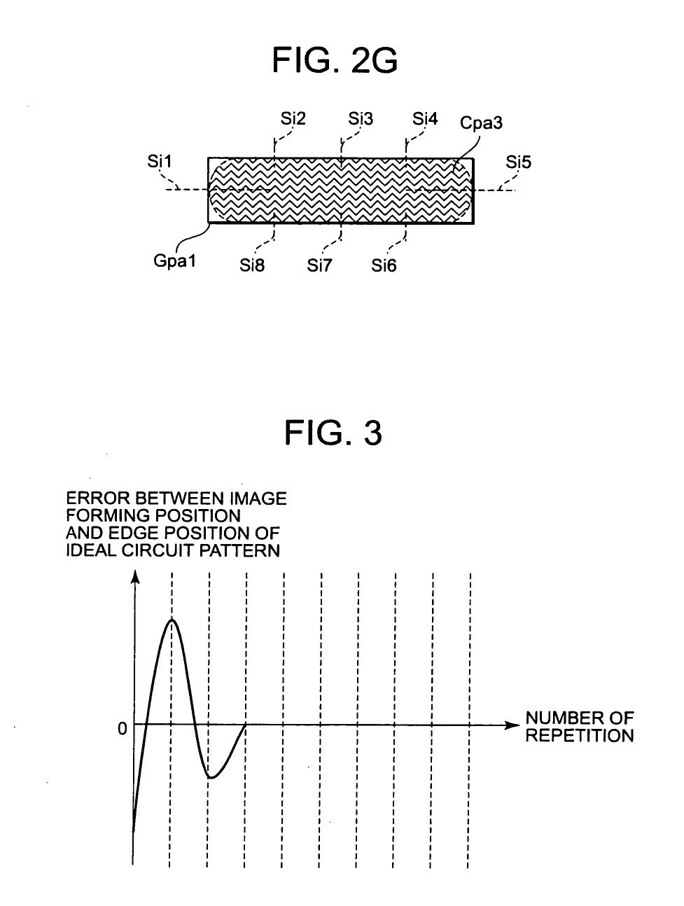

Next, more specific description is given of the flow of predicting a manufacturing deficiency part (Steps S2 to S7) illustrated in FIG. 1, referring to specific layout patterns. First, FIGS. 2A to 2G illustrate a layout pattern having no risk of occurrence of a manufacturing deficiency, that is, a layout pattern having no problem with performing the OPC processing. Then, with reference to FIGS. 2A to 2G, description is given of the processing of Steps S2 to S6.

FIG. 2A illustrates the outer shape of a layout pattern Gpa1 contained in the GDS data read out in Step S2. In Step S2, sites Si1 to Si8 are set on the layout pattern Gpa1. As illustrated in FIG. 2A, the sites Si1 to Si8 are straight lines that intersect the edges of the layout pattern Gpa1.

FIG. 2B is a schematic diagram of a layout in which edges corresponding to an OPC pattern Opa1 are generated by shifting the edges of the layout pattern Gpa1. As illustrated in FIG. 2B, the OPC pattern Opa1 has a larger area than that of the layout pattern Gpa1. This is because an image forming pattern formed on a semiconductor substrate generally becomes smaller than the layout pattern Gpa1 due to the optical proximity effect. It should be noted that, in the edge shifting step of Step S3, only coordinate information of edge positions after the shift is generated without generating the OPC pattern Opa1.

FIG. 2C is a schematic diagram of a layout pattern in a case where the edge image forming position is calculated for the OPC pattern Opa1. In order to show a specific example of the image forming position, FIG. 2C illustrates a contour pattern Cpa1 that indicates a pattern formed on the semiconductor substrate. However, in the step of calculating the edge image forming posit ion of Step S4, only coordinates of the image forming position on the sites Si1 to Si8 are obtained. Further, in FIG. 2C, on the sites Si1 and Si5, the contour pattern Cpa1 has the image forming position located inside the layout pattern Gpa1. Accordingly, errors thereof are calculated in the error check step of Step S5, and, in the next repetitive processing, the processing of shifting the edge positions is performed so as to reduce the errors.

FIG. 2D is a schematic diagram of a layout pattern obtained after the edge shift processing performed in the second repetitive processing. As illustrated in FIG. 2D, in the edge shifting step of the second repetitive processing, in consideration of the fact that the image forming position is located inside the layout pattern Gpa1 in the error check step performed last, there are generated edge position coordinates corresponding to an OPC pattern Opa2, which is obtained by enlarging the OPC pattern Opa1 at portions corresponding to the sites Si1 and Si5.

FIG. 2E is a schematic diagram of a layout pattern in a case where the edge image forming position is calculated for the OPC pattern Opa2. In order to show a specific example of the image forming position, FIG. 2E illustrates a contour pattern Cpa2 that indicates a pattern formed on the semiconductor substrate. However, in the step of calculating the edge image forming posit ion of Step S4, only coordinates of the image forming position on the sites Si1 to Si8 are obtained. Further, in FIG. 2E, on the sites Si1 and Si5, the contour pattern Cpa2 has the image forming position located outside the layout pattern Gpa1. Accordingly, errors thereof are calculated in the error check step of Step S5, and, in the next repetitive processing, the processing of shifting the edge positions is performed so as to reduce the errors.

FIG. 2F is a schematic diagram of a layout pattern obtained after the edge shift processing performed in the third repetitive processing. As illustrated in FIG. 2F, in the edge shifting step of the third repetitive processing, in consideration of the fact that the image forming position is located outside the layout pattern Gpa1 in the error check step performed last, there are generated edge position coordinates corresponding to an OPC pattern Opa3, which is obtained by reducing the OPC pattern Opa1 at portions corresponding to the sites Si1 and Si5.

FIG. 2G is a schematic diagram of a layout pattern in a case where the edge image forming position is calculated for the OPC pattern Opa3. In order to show a specific example of the image forming position, FIG. 2G illustrates a contour pattern Cpa3 that indicates a pattern formed on the semiconductor substrate. However, in the step of calculating the edge image forming posit ion of Step S4, only coordinates of the image forming position on the sites Si1 to Si8 are obtained. Further, in FIG. 2G, the edge positions of the contour pattern Cpa3 are located at substantially the same positions as the edges of the layout pattern Gpa1 on the sites Si1 to Si8. Accordingly, errors that are calculated in the error check step of Step S5 become substantially zero, and, in the following repetitive processing, those edge positions are no longer targets of the shift.

Here, FIG. 3 illustrates relation between the number of times the processing is repeated and the error between the image forming position and the edge position of an ideal circuit pattern (for example, layout pattern Gpa1) in the processing illustrated in FIGS. 2A to 2G. As illustrated in FIG. 3, in the example of FIGS. 2A to 2G, the amount of the error becomes smaller as the number of repetition increases. When the third repetitive processing has been completed, the amount of the error becomes substantially zero, which means that the error has converged. In other words, the hot spot information is not extracted from the layout pattern Gpa1 illustrated in FIGS. 2A to 2G.

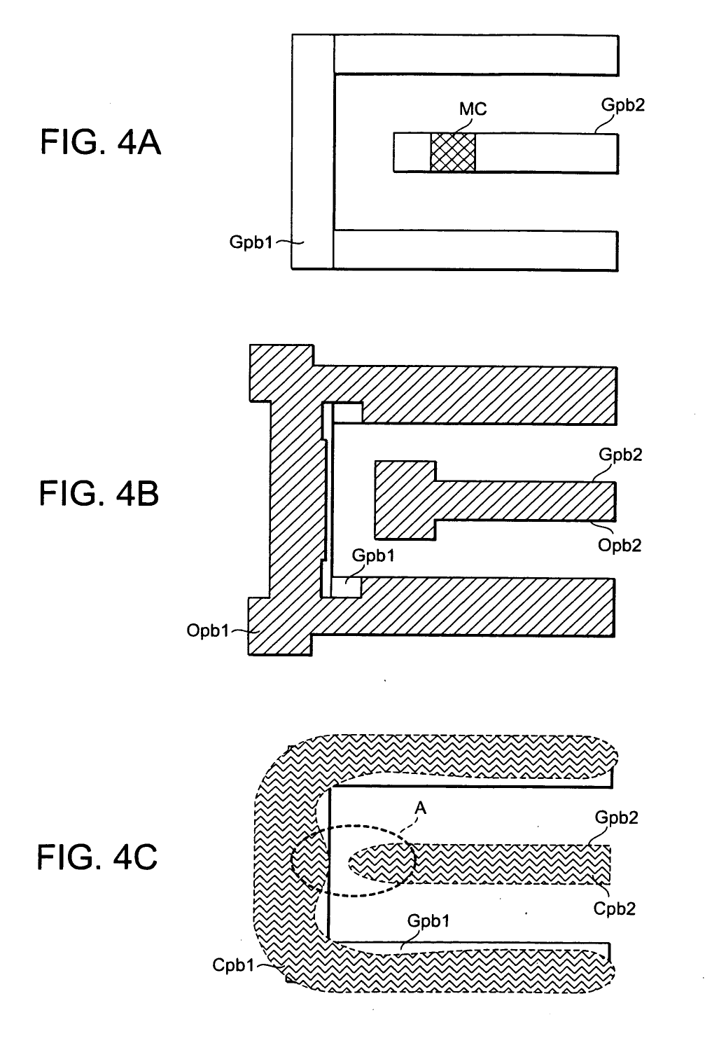

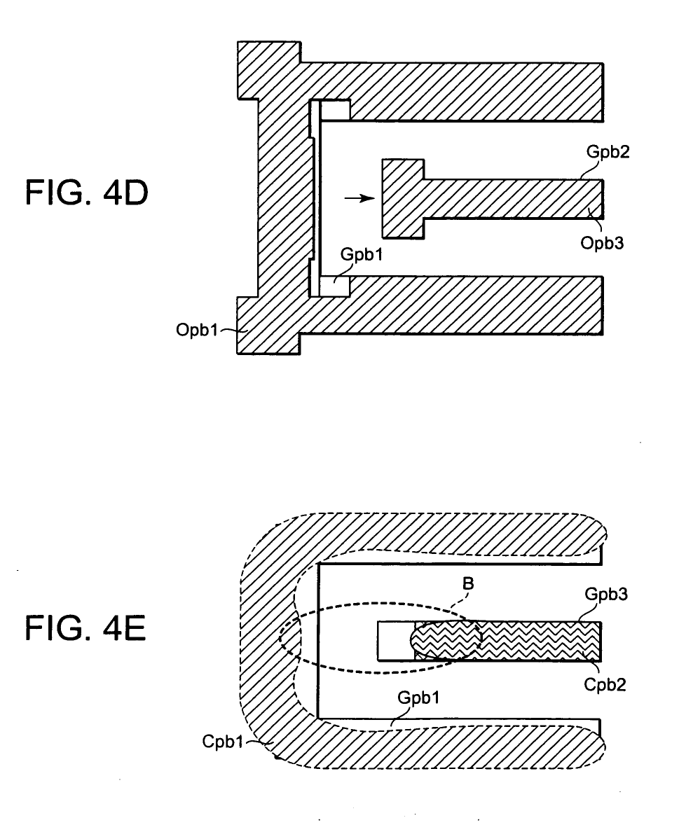

Next, FIGS. 4A to 4E, 5A to 5E, and 7A to 7E illustrate layout patterns from which the hot spot information is extracted in Step S7, and description is given of those patterns. It should be noted that illustration of the sites is omitted in FIGS. 4A to 4E, 5A to 5E, and 7A to 7E.

In the example illustrated in FIGS. 4A to 4E, there are disposed a layout pattern Gpb1 and a layout pattern Gpb2 having three sides thereof surrounded by the layout pattern Gpb1 (FIG. 4A). Then, FIG. 4B is a schematic diagram of layout patterns in a case where, in the edge shifting step, the edges have been shifted for the layout patterns illustrated in FIG. 4A. The schematic diagram of FIG. 4B illustrates OPC patterns Opb1 and Opb2 that correspond to the layout patterns Gpb1 and Gpb2, respectively. FIG. 4C illustrates contour patterns Cpb1 and Cpb2, which are obtained by calculating the image forming positions of the OPC patterns Opb1 and Opb2 illustrated in FIG. 4B. As illustrated in FIG. 4C, in this case, a pattern length of the contour pattern Cpb2 is extended in a longitudinal direction due to the optical proximity effect, which makes a distance thereof from the contour pattern Cpb1 shorter (area A). Further, the contour pattern Cpb2 has a longer pattern length than that of the layout pattern Gpb2 in the longitudinal direction (area A). Accordingly, in the next repetitive processing, the short side of the OPC pattern Opb2, which faces the OPC pattern Opb1, is retreated in the longitudinal direction.

FIG. 4D is a schematic diagram of an OPC pattern Opb3 obtained when the edge shift processing is performed in the second repetitive processing. Then, FIG. 4E illustrates contour patterns Cpb1 and Cpb3 obtained by calculating the image forming positions of the OPC patterns Opb1 and Opb3 illustrated in FIG. 4D. As illustrated in FIG. 4E, in this case, the pattern length of the contour pattern Cpb3 is reduced in the longitudinal direction due to the optical proximity effect, which makes a distance thereof from the contour pattern Cpb1 longer (area B). Further, the contour pattern Cpb3 has a shorter pattern length than the layout pattern Gpb2 in the longitudinal direction (area B). Accordingly, in the next repetitive processing, the length of the OPC pattern Opb3 is extended again in the longitudinal direction in order to reduce the error between the contour pattern Cpb3 and the layout pattern Gpb2.

However, compared with the amount of the edge shift of the OPC pattern Opb2 or the OPC pattern Opb3 in the longitudinal direction, the fluctuation of the contour pattern is larger, and hence, even if the repetitive processing is continuously performed, the states of FIGS. 4C and 4E appear one after the other by turns, for example. Accordingly, in the example illustrated in FIGS. 4A to 4E, the area A or the area B is registered as an area in which the amount of the edge shift is unstable (or does not converge), that is, as the hot spot information. Then, in the wire repair step of Step S8, by making larger a distance between the layout pattern Gpb1 and the layout pattern Gpb2, for example, the convergeability of the patterns in the OPC processing is improved.

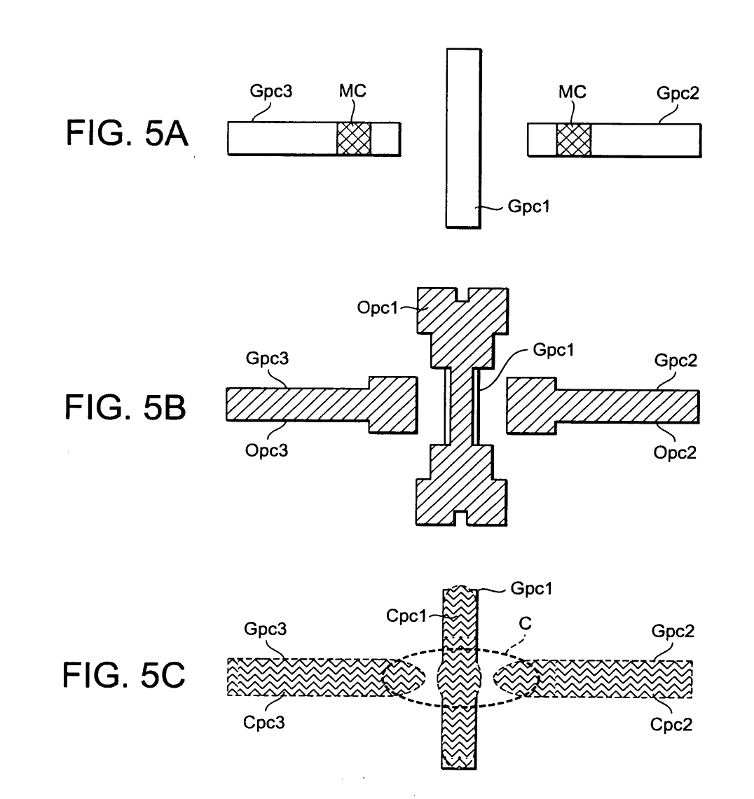

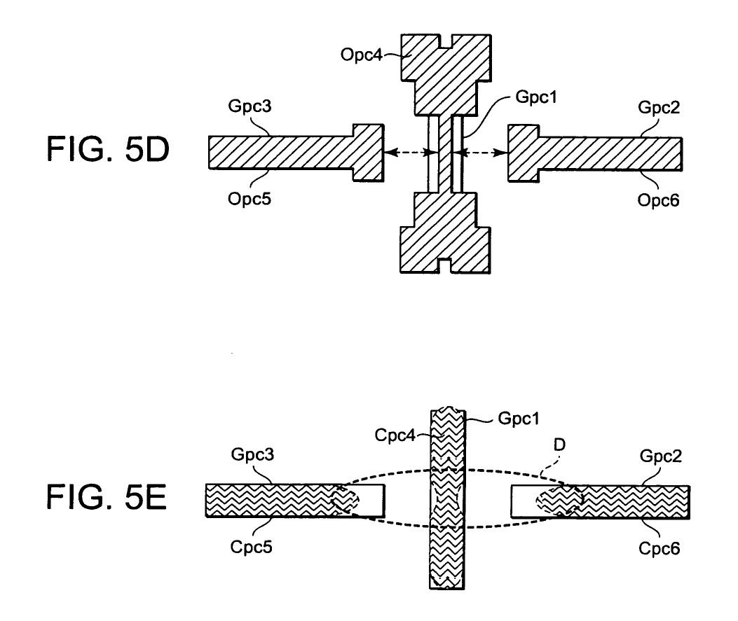

Further, in the example illustrated in FIGS. 5A to 5E, there are disposed a layout pattern Gpc1 and layout patterns Gpc2 and Gpc3 each having a short side thereof facing one side of the layout pattern Gpc1 (FIG. 5A). Then, FIG. 5B is a schematic diagram of layout patterns in a case where, in the edge shifting step, the edges have been shifted for the layout patterns illustrated in FIG. 5A. The schematic diagram of FIG. 5B illustrates OPC patterns Opc1 to Opc3 that correspond to the layout patterns Gpc1 to Gpc3, respectively. FIG. 5C illustrates contour patterns Cpc1 to Cpc3, which are obtained by calculating the image forming positions of the OPC patterns Opc1 to Opc3 illustrated in FIG. 5B. As illustrated in FIG. 5C, in this case, the pattern lengths of the contour patterns Cpc2 and Cpc3 are extended in the longitudinal direction due to the optical proximity effect, which makes wider a pattern width of the contour pattern Cpc1 at a portion at which the contour pattern Cpc1 is in close proximity of the contour patterns Cpc2 and Cpc3 (area C). In the area C, distances between the contour pattern Cpc1 and the contour patterns Cpc2 and Cpc3 become shorter. Further, the contour patterns Cpc2 and Cpc3 have longer pattern lengths than the layout patterns Gpc2 and Gpc3 in the longitudinal direction, respectively (area C). Accordingly, in the next repetitive processing, the sides of the OPC patterns Opc2 and Opc3, which face the OPC pattern Opc1, are retreated in the longitudinal direction.

FIG. 5D is a schematic diagram of OPC patterns Opc4 to Opc6 obtained when the edge shift processing is performed in the second repetitive processing. Then, FIG. 5E illustrates contour patterns Cpc4 to Cpc6 obtained by calculating the image forming positions of the OPC patterns Opc4 to Opc6 illustrated in FIG. 5D. As illustrated in FIG. 5E, in this case, the pattern lengths of the contour patterns Cpc5 and Cpc6 are reduced in the longitudinal direction due to the optical proximity effect, which makes distances thereof from the contour pattern Cpc4 longer (area D). Further, the contour patterns Cpc5 and Cpc6 have shorter pattern lengths than the layout patterns Gpc3 and Gpc2 in the longitudinal direction, respectively (area D). Further, the pattern width of the contour pattern Cpc4 becomes narrower at a portion at which the contour pattern Cpc4 is in close proximity of the contour patterns Cpc5 and Cpc6 (area D). In the area D, distances between the contour pattern Cpc4 and the contour patterns Cpc5 and Cpc6 become longer. Accordingly, in the next repetitive processing, the lengths of the OPC patterns Opc5 and Opc6 are extended again in the longitudinal direction in order to reduce the errors between the contour patterns Cpc5 and Cpc6 and the layout patterns Gpc3 and Gpc2.

However, compared with the amount of the edge shift of the OPC pattern Opc5 or the OPC pattern Opc6 in the longitudinal direction, the fluctuation of the contour patterns is larger, and hence, even if the repetitive processing is continuously performed, the states of FIGS. 5C and 5E appear one after the other by turns, for example. Accordingly, in the example illustrated in FIGS. 5A to 5E, the area C or the area D is registered as an area in which the amount of the edge shift is unstable (or does not converge), that is, as the hot spot information. Then, in the wire repair step of Step S8, by making larger distances between the layout pattern Gpc1 and the layout patterns Gpc2 and Gpc3, for example, the convergeability of the patterns in the OPC processing is improved.

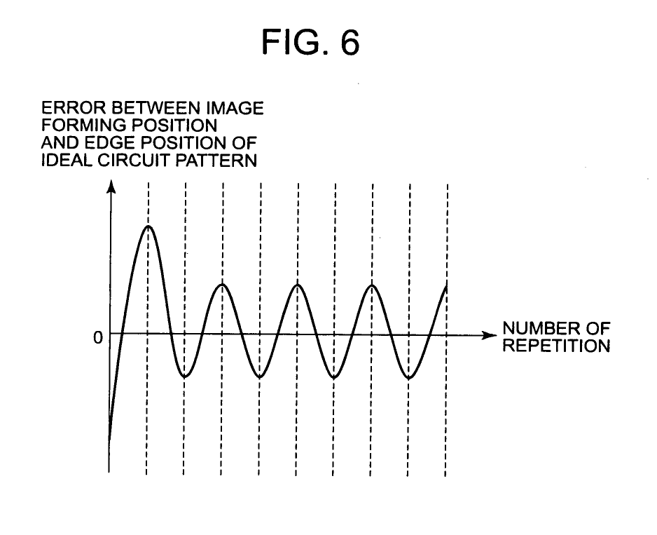

FIG. 6 illustrates relation between the number of times the processing is repeated and the error between the image forming position of the layout pattern and the edge position of an ideal circuit pattern (for example, layout patterns Gpb1 and Gpb2 or layout patterns Gpc1 to Gpc3) described with reference to FIGS. 4A to 4E and 5A to 5E. As illustrated in FIG. 6, in the examples of FIGS. 4A to 4E and 5A to 5E, the amount of the error does not become smaller even when the number of repetition increases, which means that the amount of the error does not converge. In other words, the areas A to D are extracted as the hot spot information from the layout patterns illustrated in FIGS. 4A to 4E and 5A to 5E.

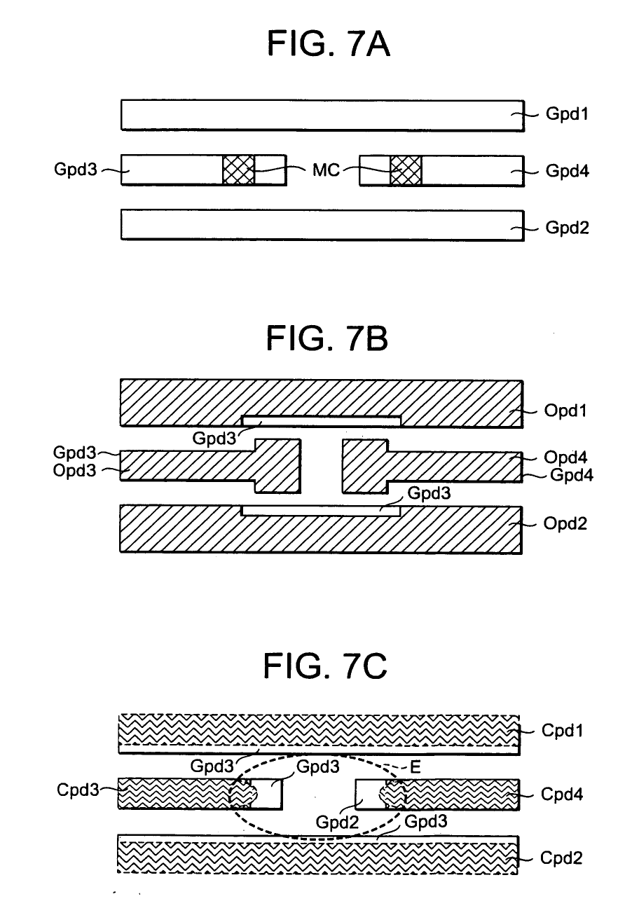

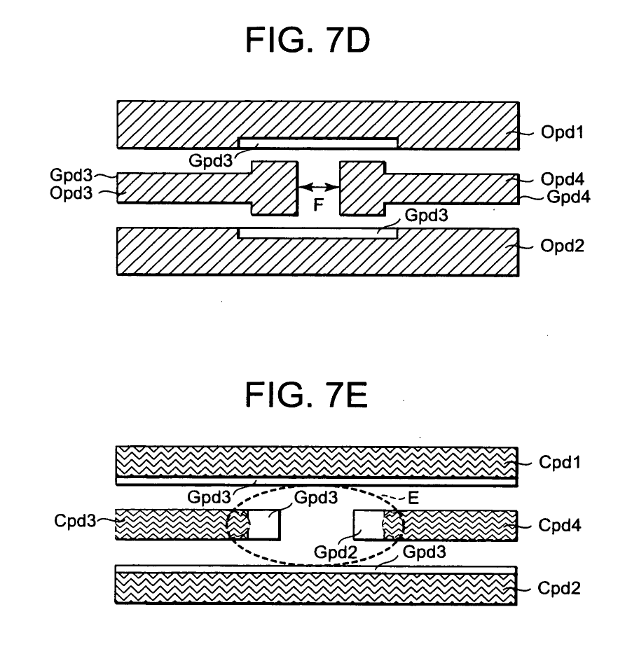

Further, FIGS. 7A to 7E illustrate another example of layout patterns from which the hot spot information is extracted. The example illustrated in FIGS. 7A to 7E includes layout patterns Gpd1 to Gpd4. The layout patterns Gpd1 and Gpd2 are such patterns that extend along the lateral direction of FIGS. 7A to 7E. Further, the layout patterns Gpd3 and Gpd4 are such patterns that are sandwiched between the layout patterns Gpd1 and Gpd2 and have short sides thereof facing each other.

Then, FIG. 7B is a schematic diagram of layout patterns in a case where, in the edge shifting step, the edges have been shifted for the layout patterns illustrated in FIG. 7A. The schematic diagram of FIG. 7B illustrates OPC patterns Opd1 to Opd4 corresponding to the layout patterns Gpd1 to Gpd4, respectively. Then, FIG. 7C illustrates contour patterns Cpd1 to Cpd4 obtained by calculating the image forming positions of the OPC patterns Opd1 to Opd4 illustrated in FIG. 7B. As illustrated in FIG. 7C, in this case, the pattern lengths of the contour patterns Cpd3 and Cpd4 are reduced in the longitudinal direction due to the optical proximity effect (area E). In the area E, a distance between the contour patterns Cpd3 and Cpd4 becomes longer. Further, the contour patterns Cpd3 and Cpd4 have longer pattern lengths than the layout patterns Gpd3 and Gpd4 in the longitudinal direction, respectively (area E). Accordingly, in the next repetitive processing, the edge positions are changed so that the distance between the OPC patterns Opd3 and Opd4 becomes smaller.

FIG. 7D is a schematic diagram of the OPC patterns Opd1 to Opd4 obtained when the edge shift processing is performed in the second repetitive processing. As illustrated in FIG. 7D, in the example illustrated in FIGS. 7A to 7E, the distance between the OPC patterns Opd3 and Opd4 needs to be made shorter in the second repetitive processing. However, it is impossible to reduce the distance because of a minimum wiring space F of reticle manufacturing. Consequently, as illustrated in FIG. 7E, the contour patterns Cpd1 to Cpd4 obtained by calculating the image forming positions of the OPC patterns Opd1 to Opd4 are identical to the contour patterns illustrated in FIG. 7C. Accordingly, even if the repetitive processing is continued thereafter, the distance between the contour patterns Cpd3 and Cpd4 does not become shorter. Even in such a case, according to the method of predicting a manufacturing defect part of a semiconductor device according to this embodiment, the area E is extracted as a hot spot based on values of the error information in the step of extracting a lithography deficiency part of Step S7. It should be noted that, in the example illustrated in FIGS. 7A to 7E, the patterns are fixed so that the distance between the layout patterns Gpd3 and Gpd4 becomes longer in the wire repair step of Step S8. Just to make sure, there is also disposed metal contact MC in FIG. 4A, FIG. 5A, and FIG. 7A.

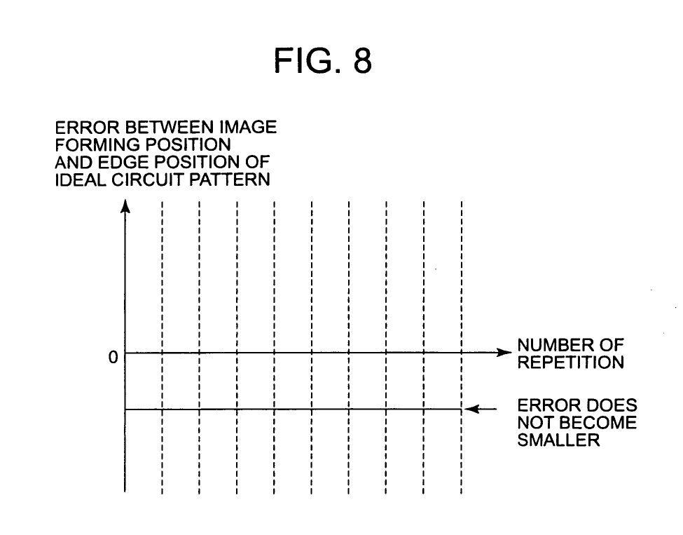

FIG. 8 illustrates relation between the number of times the processing is repeated and the error between the image forming position of the layout pattern and the edge position of an ideal circuit pattern (for example, layout patterns Gpd1 to Gpd4) described with reference to FIGS. 7A to 7E. As illustrated in FIG. 8, in the example of FIGS. 7A to 7E, even when the number of repetition increases, the amount of the error does not become smaller though the amount of the error converges.

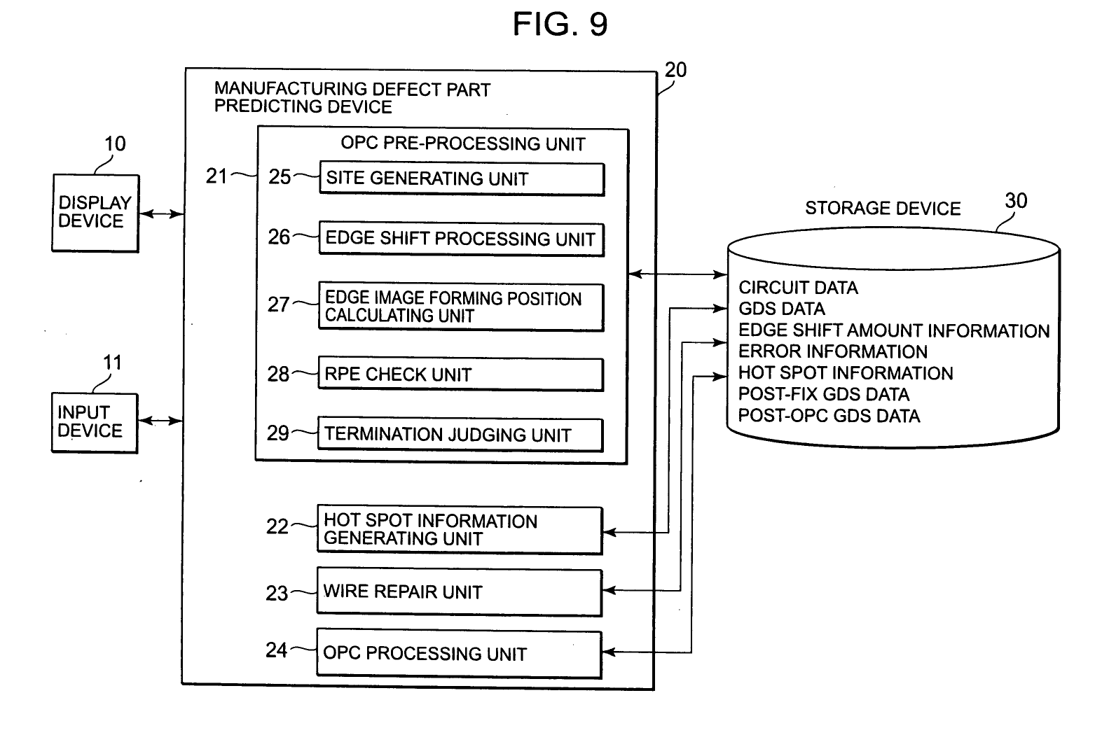

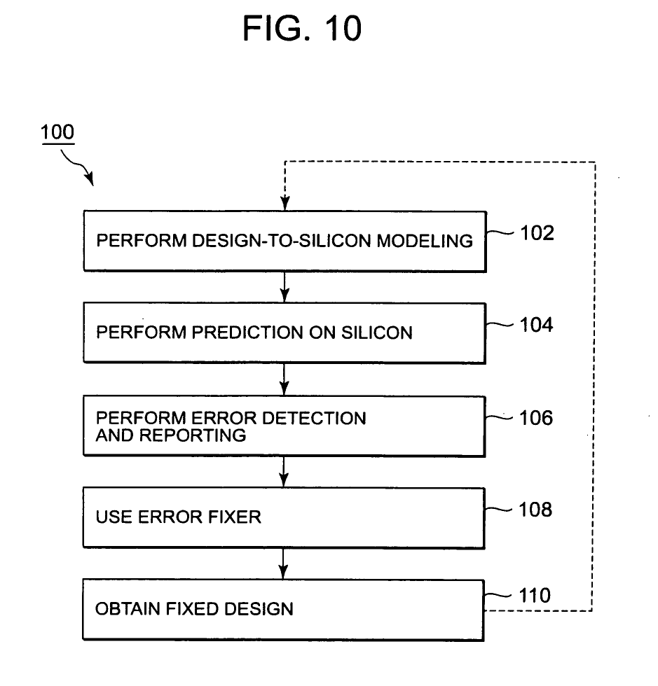

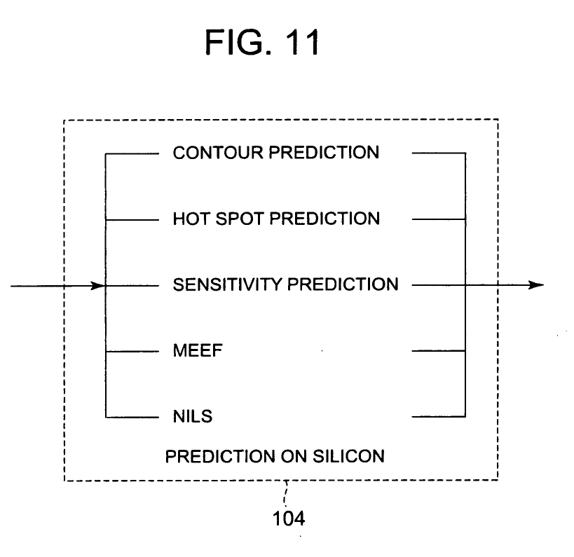

Here, description is given of a case in which the above-mentioned method of predicting a manufacturing defect part of a semiconductor device is realized by hardware. FIG. 9 is a block diagram of a manufacturing defect part predicting device 20 that realizes the method of predicting a manufacturing defect part of a semiconductor device according to this embodiment. As illustrated in FIG. 9, the manufacturing defect part predicting device 20 includes an OPC pre-processing unit 21, a hot spot information generating unit 22, a wire repair unit 23, and an OPC processing unit 24. It should be noted that the wire repair unit 23 and the OPC processing unit 24 may be implemented as separate devices from the manufacturing defect part predicting device 20. Further, the manufacturing defect part predicting device 20 is connected to a display device 10, an input device 11, and a storage device 30.

The display device 10 displays an interface for operating the manufacturing defect part predicting device 20. The input device 11 is an input interface for a user to operate the manufacturing defect part predicting device 20. The storage device 30 stores data to be provided to the manufacturing defect part predicting device 20 and data to be output from the manufacturing defect part predicting device 20.

The OPC pre-processing unit 21 includes a site generating unit 25, an edge shift processing unit 26, an edge image forming position calculating unit 27, an error check unit (for example, EPE check unit) 28, and a termination judging unit 29. The site generating unit 25 executes the site generating step, which is Step S2 of FIG. 1. More specifically, the site generating unit 25 reads out the GDS data from the storage device 30, and then sets sites on the read-out GDS data.

The edge shift processing unit 26 executes the edge shifting step, which is Step S3 of FIG. 1. More specifically, the edge shift processing unit 26 shifts the edges of a layout pattern contained in the GDS data that is read out from the storage device 30 by the site generating unit 25 according to a predetermined rule. Then, the edge shift processing unit 26 accumulates, for each repetitive processing, edge shift amount information in the storage device 30.

The edge image forming position calculating unit 27 executes the step of calculating an edge image forming position, which is Step S4 of FIG. 1. More specifically, the edge image forming position calculating unit 27 obtains, through calculation, coordinate information of the image forming position on the semiconductor substrate with regard to the edge shifted by the edge shift processing unit 26. Further, the edge image forming position calculating unit 27 calculates the coordinate information of the sites set by the site generating unit 25.

The EPE check unit 28 executes the error check step, which is Step S5 of FIG. 1. More specifically, the EPE check unit 28 calculates an error between the image forming position on a site and the edge position of a layout pattern, and then outputs the calculated error as the error information. It should be noted that the image forming position and the edge position of the layout pattern are located on the same site. The EPE check unit 28 accumulates the calculated error information in the storage device 30 every time the repetitive processing is performed.

The termination judging unit 29 executes the step of judging termination of the OPC pre-processing, which is Step S6 of FIG. 1. More specifically, based on at least one of the error information output by the error check unit 28 and the number of times the repetitive processing has been performed, the termination judging unit 29 judges whether or not the repetitive processing performed by the OPC pre-processing unit 21 is to be continued. It should be noted that, in this embodiment, the termination judging unit 29 employs a configuration in which the termination judgment is performed based on the number of times the repetitive processing has been performed.

The hot spot information generating unit 22 executes the step of extracting a lithography deficiency part, which is Step S7 of FIG. 1. More specifically, the hot spot information generating unit 22 uses at least one of the edge shift amount information and the error information to predict a part having a high risk of occurrence of a lithography deficiency, and then outputs the predicted part as the hot spot information. Then, the hot spot information is stored in the storage device 30.

The wire repair unit 23 executes the wire repair step, which is Step S8 of FIG. 1. More specifically, the wire repair unit 23 reads out the hot spot information and the GDS data from the storage device 30, and then fixes a layout pattern of the GDS data, which corresponds to a risk-predicted part contained in the hot spot information. Then, the wire repair unit 23 causes the storage device 30 to store the fixed GDS data as post-fix GDS data.

The OPC processing unit 24 executes the OPC processing step, which is Step S9 of FIG. 1. More specifically, the OPC processing unit 24 uses the above-mentioned OPC pre-processing unit 21 to generate post-OPC GDS data, and then performs lithography simulation and rule check with respect to the post-OPC GDS data. In other words, the OPC processing unit 24 performs only the lithography simulation and the rule check. Further, the processing of the OPC processing step (Step S9) is realized by the OPC pre-processing unit 21 and the OPC processing unit 24.

As described above, the method of predicting a manufacturing defect part of a semiconductor device according to this embodiment can be realized by causing the hardware to execute the respective flows of the processing. On this occasion, the blocks of the manufacturing defect part predicting device 20 respectively perform arithmetic computations, but those arithmetic computations may be performed by a general-purpose arithmetic circuit such as a central processing unit (CPU). In the case where a general-purpose arithmetic circuit is used, the arithmetic circuit executes a prediction program for causing the arithmetic circuit to execute the respective processing flows of the method of predicting a manufacturing defect part of a semiconductor device. Then, by operating the arithmetic circuit and the storage device 30 according to the prediction program, the method of predicting a manufacturing defect part of a semiconductor device according to this embodiment can be realized with the program installed onto the hardware.

As can be understood from the above description, with the method of predicting a manufacturing defect part of a semiconductor device according to this embodiment, it is possible to predict a part having a high risk of occurrence of a manufacturing defect (lithography defect) based on the edge shift amount information output in the edge shifting step (Step S3) in which the outer shape of an OPC pattern is obtained in the OPC pre-processing or the error information output in the error check step (Step S5). In the OPC pre-processing, the calculation of displacement of an image forming pattern, which is caused by the optical proximity effect, is performed only with respect to the coordinates on the sites. In other words, a contour pattern is not generated in the OPC pre-processing. However, with the method of predicting a manufacturing defect part of a semiconductor device according to this embodiment, it is possible to predict a part (hot spot) having a high risk for a manufacturing defect part of a semiconductor device with a small amount of calculation. Further, owing to the fact that a hot spot can be predicted in a short period of time, the method of predicting a manufacturing defect part of a semiconductor device according to this embodiment makes it possible to shorten a period of time necessary for the design process.

The effect of shortening a period of time in the design process can be recognized especially in designing such a semiconductor device that has high density integrated circuits and has a complicated layout pattern. For example, in a case of a complicated layout pattern, even if the layout pattern is once fixed based on the hot spot information, a hot spot may be further formed in another part. In such a case, it is necessary to predict a hot spot a plurality of times to perform fix thereof. Accordingly, when a semiconductor device having a complicated layout pattern is designed, there occurs a case in which a period of time necessary for the design process becomes enormous along with an increased number of times a hot spot is predicted. In this case, by employing the method of predicting a manufacturing defect part of a semiconductor device according to this embodiment, it becomes possible to shorten a period of time to be necessary in each of a plurality of hot spot predictions, and hence the effect of shortening a period of time in the design process can be obtained more distinguishedly.

Further, in the method of predicting a manufacturing defect part of a semiconductor device according to this embodiment, the GDS data is fixed based on the predicted hot spot information, to thereby fix the part that is predicted to have occurrence of a lithography defect. With this configuration, it is possible to avoid a lithography defect of a semiconductor device to be formed based on the post-OPC GDS data generated based on the post-fix GDS data.

Further, in the method of predicting a manufacturing defect part of a semiconductor device according to this embodiment, information to be used for hot spot prediction is generated by using the processing flow of the OPC pre-processing included in the OPC processing. In other words, no new processing flow is added in order to realize the method of predicting a manufacturing defect part of a semiconductor device according to this embodiment. Therefore, the method of predicting a manufacturing defect part of a semiconductor device according to this embodiment is easier to realize compared to other methods for enhancing the speed of the OPC processing.

It should be noted that the present invention is not limited to the above-mentioned embodiment, and may be changed as appropriate without departing from the spirit and scope of the present invention.

What is claimed is:

1. A method of predicting a manufacturing defect part of a semiconductor device, which results from optical pattern displacement that occurs in an exposure process of a process of manufacturing the semiconductor device, the prediction method comprising:
performing repetitive processing a plurality of times, the repetitive processing comprising:
a site generating step of setting a site at a predetermined position of a layout pattern of first layout data generated based on data on a circuit to be formed on a semiconductor substrate;
an edge shifting step of shifting an edge of the layout pattern according to a predetermined rule;
an image forming position calculating step of calculating an image forming position corresponding to the shifted edge on the site; and
an error check step of calculating an error between the image forming position on the site and the edge of the layout pattern, and storing the calculated error as error information; and
extracting, based on the error information, from the first layout data, apart in which the image forming position is unstable, and predicting the extracted part as an area having a high risk of a manufacturing defect.

2. A method of predicting a manufacturing defect part of a semiconductor device according to claim 1, wherein the error information is obtained by accumulating information on an error calculated in each cycle of the repetitive processing.

3. A method of predicting a manufacturing defect part of a semiconductor device according to claim 1, wherein the edge shifting step comprises accumulating edge shift amount information calculated in each cycle of the repetitive processing every time the repetitive processing is performed.

4. A method of predicting a manufacturing defect part of a semiconductor device according to claim 1, wherein:
the site comprises information represented by a straight line passing across an edge position of the layout pattern, an edge position obtained by the shifting in the edge shifting step, and the image forming position;
the image forming position calculating step comprises calculating, as the image forming position, intersection coordinates of the site and the edge position obtained by the shifting in the edge shifting step; and
the error check step comprises calculating an error between the image forming position and the intersection coordinates of the site and the edge position of the layout pattern.

5. A method of predicting a manufacturing defect part of a semiconductor device according to claim 1, wherein the area having the high risk of the manufacturing defect is obtained based on at least one of the error information and edge shift amount information output in the edge shifting step.

6. A method of predicting a manufacturing defect part of a semiconductor device according to claim 1, wherein the semiconductor device is manufactured based on third layout data, the third layout data being generated by performing optical proximity correction processing on second layout data generated by correcting the layout pattern of the first layout data based on a result of the predicting.

7. A device for predicting a manufacturing defect part of a semiconductor device, which results from optical pattern displacement that occurs in an exposure process of a process of manufacturing the semiconductor device, the prediction device comprising:
a site generating unit for setting a site at a predetermined position of a layout pattern of first layout data generated based on data on a circuit to be formed on a semiconductor substrate;
an edge shifting unit for shifting an edge of the layout pattern according to a predetermined rule;
an image forming position calculating unit for calculating an image forming position corresponding to the shifted edge on the site;
an error check unit for calculating an error between the image forming position on the site and the edge of the layout pattern, and outputting the calculated error as error information; and
a hot spot information generating unit for extracting, based on the error information, from the first layout data, a part in which the image forming position is unstable, and predicting the extracted part as a hot spot area having a high risk of a manufacturing defect.

8. A device for predicting a manufacturing defect part of a semiconductor device according to claim 7, further comprising a termination judging unit for judging, based on at least one of the error information output by the error check unit and a number of times repetitive processing is performed, whether or not to continue the repetitive processing performed by the edge shifting unit, the image forming position calculating unit, and the error check unit.

9. A device for predicting a manufacturing defect part of a semiconductor device according to claim 8, wherein the error information is obtained by accumulating information on an error calculated in each cycle of the repetitive processing.

10. A device for predicting a manufacturing defect part of a semiconductor device according to claim 8, wherein the edge shifting unit accumulates edge shift amount information calculated in each cycle of the repetitive processing every time the repetitive processing is performed.

11. A device for predicting a manufacturing defect part of a semiconductor device according to claim 7, wherein:
the site comprises information represented by a straight line passing across an edge position of the layout pattern, an edge position shifted by the edge shifting unit, and the image forming position;
the image forming position calculating unit calculates, as the image forming position, intersection coordinates of the site and the edge position shifted by the edge shifting unit; and
the error check unit calculates an error between the image forming position and the intersection coordinates of the site and the edge position of the layout pattern.

12. A device for predicting a manufacturing defect part of a semiconductor device according to claim 7, further comprising an OPC processing unit for generating third layout data corresponding to a circuit pattern to be formed on the semiconductor device,
wherein the OPC processing unit performs optical proximity correction processing on second layout data generated by correcting the layout pattern of the first layout data based on hot spot information, to thereby generate the third layout data.

13. A program operated on a computer comprising a storage device and an arithmetic device, for predicting a manufacturing defect part of a semiconductor device, which results from optical pattern displacement that occurs in an exposure process of a process of manufacturing the semiconductor device, the prediction program causing the arithmetic device to execute:
a site generating step of reading out, from the storage device, first layout data generated based on data on a circuit on the semiconductor device, and setting a site at a predetermined position of a layout pattern of the first layout data;
an edge shifting step of shifting an edge of the layout pattern according to a predetermined rule;
an image forming position calculating step of calculating an image forming position corresponding to the shifted edge on the site; and
an error check step of calculating an error between the image forming position on the site and the edge of the layout pattern, and storing the calculated error as error information,
wherein the arithmetic device extracts, based on the error information, from the first layout data, a part in which the image forming position is unstable, and predicts the extracted part as an area having a high risk of a manufacturing defect.

14. A program for predicting a manufacturing defect part of a semiconductor device according to claim 13, further causing the arithmetic device to execute a termination judging step of judging, based on at least one of the error information output in the error check step and a number of times repetitive processing is performed, whether or not to continue the repetitive processing performed in the edge shifting step, the image forming position calculating step, and the error check step.

15. A program for predicting a manufacturing defect part of a semiconductor device according to claim 14, wherein the error information is obtained by accumulating information on an error calculated in each cycle of the repetitive processing.

16. A program for predicting a manufacturing defect part of a semiconductor device according to claim 14, wherein the edge shifting step comprises accumulating edge shift amount information calculated in each cycle of the repetitive processing every time the repetitive processing is performed.

17. A program for predicting a manufacturing defect part of a semiconductor device according to claim 13, wherein:
the site comprises information represented by a straight line passing across an edge position of the layout pattern, an edge position obtained by the shifting in the edge shifting step, and the image forming position;
the image forming position calculating step comprises calculating, as the image forming position, intersection coordinates of the site and the edge position obtained by the shifting in the edge shifting step; and
the error check step comprises calculating an error between the image forming position and the intersection coordinates of the site and the edge position of the layout pattern.

18. A program for predicting a manufacturing defect part of a semiconductor device according to claim 13, further causing the arithmetic device to execute an OPC processing step of generating third layout data corresponding to a circuit pattern to be formed on the semiconductor device,
wherein the OPC processing step comprises performing optical proximity correction processing on second layout data generated by correcting the layout pattern of the first layout data based on hot spot information, to thereby generate the third layout data.
